(19) United States
(12) Patent Application Publication
(10) Pub. No.: US 2013/0267545 A1
(43) Pub. Date: Oct. 10, 2013

(54) METHOD OF IMPROVING PLANT GROWTH BY REDUCING FUNGAL INFECTIONS

(71) Applicants: Randy Allen Myers, Cary, NC (US); James Bloomberg, Morrisville, NC (US); James Alan Hopkins, Collierville, TN (US)

(72) Inventors: Randy Allen Myers, Cary, NC (US); James Bloomberg, Morrisville, NC (US); James Alan Hopkins, Collierville, TN (US)

(73) Assignee: BAYER CROPSCIENCE LP, Research Triangle Park, NC (US)

(21) Appl. No.: 13/810,973

(22) PCT Filed: Jun. 15, 2011
(86) PCT No.: PCT/US11/40472

§ 371 Date: Feb. 27, 2013

Related U.S. Application Data
(60) Provisional application No. 61/372,607, filed on Aug. 11, 2010.

(51) Int. Cl. A01N 43/653; A01N 43/54; A01N 37/50

(52) U.S. Cl. CPC A01N 43/653; A01N 37/50; A01N 43/54
USPC 514/269

(57) ABSTRACT

A method of improving the growth of plants such as corn, soybean, wheat, or rice is provided by reducing the incidence of one or more fungal infections. The method comprises the step of applying a foliar treatment composition at least once to established plants, wherein the treatment composition comprises effective amounts of active ingredients prothioconazole, trifloxystrobin, and azoxystrobin.

### FIELD OF THE INVENTION

The present invention is directed to methods of improving plant growth by reducing the incidence of fungal infections.

### BACKGROUND OF THE INVENTION

In the agricultural chemical industry, triazoles and strobilurins are currently the two most important classes of fungicides on row crops. They tend to complement each other when applied together. Currently, several major agricultural chemical companies market products which combine active ingredients from the two classes into commercial products. Examples include STRATEGO, available from Bayer CropScience, QUILT, available from Syngenta, and TWINLINE, available from BASF.

U.S. Pat. Nos. 5,246,954 and 5,358,958 disclose the use of the fungicide 2-(4-chlorobenzylidene)-5,5-diemethyl-1-(1H-1,2,4-triazol-1-ylmethyl)-1-cyclopentanol in combination with numerous other fungicides, including triazoles.

U.S. Pat. Nos. 6,355,634 and 6,407,100 disclose numerous oxime ethers, including trifloxystrobin, as suitable for use as fungicides.

It is known that 2-[2-(1-chlorocyclopropyl)-3-(2-chlorophen-yl)-2-hydroxypropyl]-2,4-dihydro-[1,2,4]-triazole-3-thione, also known as prothioconazole, has fungicidal properties. Like other fungicides, the activity of this compound is good; however, at low application rates it is in some cases not satisfactory. Numerous prothioconazole-based products have been introduced by Bayer CropScience into the market since 2004 under brands such as Proline® and Prosaro®. United States Patent Application Publication Number 20050101639 is drawn to fungicidal mixtures based on prothioconazole and a strobilurin derivative. The preparation of a number of agricultural microbiocides such as prothioconazole, prepared from triazolyl derivatives, is disclosed in U.S. Pat. No. 5,789,430.

Methyl (E)-2-[2-[6-(2-cyanophenoxy)pyrimidin-4-yl]oxyphenyl]-3-methoxy-prop-2-enoate (also known as azoxystrobin) is a strobilurin-type fungicide commonly used in agriculture. Azoxystrobin possesses one of the broadest spectra of activity of all presently known antifungals. It has the ability to protect against the four major groups of fungal diseases:
Ascomycota: Septoria
Deuteromycota: Pyricularia (rice harvesting)
Basidiomycota: Rusts
Oomycota: Water mould (grape harvesting)

Azoxystrobin is widely used in wheat farming. Applying agents containing azoxystrobin provides protection against many types of diseases, including:
Wheat tan spot
Septoria leaf spot
Rusts (Puccinia spp.)
Powdery mildew
Downy mildew
Sheath blight (Rhizoctonia solani)

U.S. Pat. No. 5,145,856 discloses a class of fungicides that includes azoxystrobin.

U.S. Pat. No. 7,309,711 discloses the use of 2′-cyano-3,4-dichloroisothiazole-5-carboxanilide derivatives in combination with any of azoxystrobin, trifloxystrobin, and prothioconazole. Likewise, U.S. Pat. No. 6,277,856 discloses the use of an azolopyrimidine in combination with, inter alia, a fungicidal triazole derivative and/or a synthetic strobilurin derivative.

Prothioconazole, as with many triazoles, is systemic in the apoplast of the plant, and demonstrates curative activity on existing fungal infections. Azoxystrobin and trifloxystrobin (benzeneacetic acid, (E,E)-alpha-(methoxyimino)-2-[[[[1-[3-(trifluoromethyl)phenyl]ethylidene]amino]oxy]methyl]-methylester) are strobilurin chemistries, and tend to show more preventative activity against fungal infections when compared with triazole fungicides. Strobilurin chemistries inhibit mitochondrial respiration in fungi, stopping their energy supply. Trifloxystrobin is not systemic in nature, but rather is redistributed on the plant surfaces through movement in the waxy layers and via a vapor phase. Such activity is unique to trifloxystrobin among currently registered strobilurin chemistries. Azoxystrobin, however, moves systemically in the plant's apoplast, and may be transported into tissue not receiving a direct application.

Since the active ingredients azoxystrobin, trifloxystrobin, and prothioconazole have different, but potentially complementary characteristics, it would be desirable to develop a method of improving plant growth that would result in better protection of a target plant from a broad array of pathogenic fungi. An effective chemical treatment would exploit the chemical advantages of each ingredient and overcome the inadequacies of the known control measures and improve plant growth through faster emergence, greater crop yields, higher protein content, more developed root systems, tillering increases, increases in plant height, bigger leaf blades, fewer dead basal leaves, stronger tillers, greener leaf color, earlier flowering, early grain maturity, increased shoot growth, and/or improved plant vigor, using lower amounts of each ingredient than would be necessary using each ingredient alone.

### SUMMARY OF THE INVENTION

A method of improving the growth of a plant is provided. For the purposes of the present invention, the phrase “improving the growth of a plant” means that plant growth is improved by reducing the incidence of one or more fungal infections. The method comprises the step of applying a foliar treatment composition at least once to established plants, wherein the treatment composition comprises effective amounts of active ingredients prothioconazole, trifloxystrobin, and azoxystrobin.

### DETAILED DESCRIPTION OF THE INVENTION

Other than in the operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of 1″ to 10″ is intended to include all sub-ranges between and including the recited minimum value of 1 and the recited maximum value of 10, that is, having a minimum value equal to or greater than 1 and a maximum value of equal to or less than 10.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa; e. g., the singular forms “a,” “an,” and “the” include plural referents unless expressly and unequivocally limited to one referent.

With respect to the present invention, the phrase “effective amount” as used herein is intended to refer to an amount of an ingredient used such that a noticeable reduction in effects caused by fungal infections is observed in plants treated using the method of the present invention, compared to plants that did not receive such treatment.

The method of the present invention comprises the step of applying a foliar treatment composition at least once to an established plant, wherein the treatment composition comprises effective amounts of active ingredients prothioconazole, trifloxystrobin, and azoxystrobin. The foliar treatment composition may be applied additional times at appropriate intervals as necessary.

The method of the present invention improves plant growth by reducing the incidence of one or more fungal infections, for example, gray leaf spot, common rust, southern rust, wheat leaf rust, Septoria, Pyricularia, and/or anthracnose. Plants that may be treated using the method of the present invention include flowering and ornamental plants and shrubs as well as crops. Crops that can be treated using the present method include grains, such as wheat, barley, rye, oats, rice, corn and sorghum; and legumes, such as beans, lentils, peas and soybeans. Plants most often treated by the method of the present invention include those most vulnerable to the above-noted fungi, in particular, corn, soybean, wheat, or rice.

As noted above, the composition is typically applied to established plants; i. e., plants having at least two mature leaves. In the method of the present invention, it has been observed that the effective amounts of each active ingredient required to observe improvement in plant growth are less than the amounts of each active ingredient required to obtain similar growth improvements in a similar method using only one or two of the same active ingredients. In other words, for example, when prothioconazole alone or a combination of prothioconazole and trifloxystrobin is used to improve plant growth, higher amounts of each active ingredient is needed than when the combination of the three active ingredients is used, as in the method of the present invention, in order to achieve the same results.

In the method of the present invention, prothioconazole is typically applied in an amount of 35 to 150, often 35 to 40 g/hectare, depending on the plant being treated. In particular embodiments of the present invention, the prothioconazole is applied in an amount of 37 g/hectare. The trifloxystrobin is typically applied in an amount of 50 to 110, often 50 to 60 g/hectare, again, depending on the plant being treated. In particular embodiments of the present invention, the trifloxystrobin is applied in an amount of 55 g/hectare. The azoxystrobin is typically applied in an amount of 50 to 110, often 50 to 60 g/hectare, again, depending on the plant being treated. In particular embodiments of the present invention, the azoxystrobin is applied in an amount of 55 g/hectare. Note that each of the active ingredients may be used in amounts greater than or less than those recited above, provided they are used at least in amounts that are sufficient to demonstrate effectiveness upon application.

The treatment composition used in the method of the present invention may be provided as an emulsifiable concentrate, suspension concentrate, directly sprayable or dilutable solution, a coatable paste, or dilute emulsion. When provided as a liquid, the composition is most often aqueous, but other solvents including alcohols, ketones, petroleum fractions, aromatic or paraffinic hydrocarbons, chlorinated hydrocarbons, liquefied gases, and the like, are suitable and may be used alone or in combination with each other or water. When provided in a solid form, the composition may be a wettable powder, soluble powder, dispersible powder, dust, granules or capsules. Inert solid carriers such as clays, natural or synthetic silicates, silica, resins, waxes, and/or solid fertilizers may be used.

The treatment composition may optionally include auxiliary agents commonly used in agricultural treatment formulations and known to those skilled in the art. Examples include wetting agents, dispersants, emulsifiers, penetrants, preservatives, antifreezes and evaporation inhibitors such as glycerol and ethylene or propylene glycol, sorbitol, sodium lactate, fillers, carriers, colorants including pigments and/or dyes, pH modifiers (buffers, acids, and bases), salts such as calcium, magnesium, ammonium, potassium, sodium, and/or iron chlorides, fertilizers such as ammonium sulfate and ammonium nitrate, urea, and defoamers.

Suitable defoamers include all customary defoamers including silicone-based and those based upon perfluoroalkyl phosphinic and phosphonic acids, in particular silicone-based defoamers, such as silicone oils, for example.

Defoamers most commonly used are those from the group of linear polydimethylsiloxanes having an average dynamic viscosity, measured at 25° C., in the range from 1000 to 8000 mPas (mPas=millipascal-second), usually 1200 to 6000 mPas, and containing silica. Silica includes polysilicic acids, meta-silicic acid, ortho-silicic acid, silica gel, silicic acid gels, kieselguhr, precipitated SiO₂, and the like.

Defoamers from the group of linear polydimethylsiloxanes contain as their chemical backbone a compound of the formula HO—[Si(CH₃)₂—O—]ₙ—H, in which the end groups are modified, by etherification for example, or are attached to the groups —Si(CH₃)₃. Non-limiting examples of defoamers of this kind are RHODORSIL® Antifoam 416 (Rhodia) and RHODORSIL® Antifoam 481 (Rhodia). Other suitable defoamers are RHODORSIL® 1824, ANTIMUSSOL 4459-2 (Clariant), Defoamer V 4459 (Clariant), SE Visk and AS EM SE 39 (Wacker). The silicone oils can also be used in the form of emulsions.

The present invention will further be described by reference to the following examples. The examples are merely illustrative of the invention and are not intended to be limiting. Unless otherwise indicated, all parts are by weight.

### EXAMPLES

### Example 1

### Soybean

Soybean seed was secured for an in-field research trial. The soybean seed is genetically modified to be tolerant to applications of HPPD (4-hydroxyphenyl-pyruvate-dioxygenase) inhibiting herbicides (example: BALANCE PRO or isoxaflutole) and glyphosate (ROUNDUP ORIGINAL MAX). The trait is known as FG72.

The site, located in Molino, Fla., was conventionally tilled and free of weeds at the time of planting. For each treatment, the soybean seed was planted in 6 meter long double rows on Jun. 29, 2009. Each treatment sample was planted in four replicates. Broadcast spray treatments were applied on Aug. 21, 2009, to established plants.

Eight treatment samples were prepared for comparison (Treatment samples 6 and 7 are representative of the present invention):
1. The check (control) in the field trial received no application of any fungicides that may have an impact on soybean growth.
2. PROPICONAZOLE (91.5 G A/HA)+TRIFLOXYSTROBIN (91.5 G A/HA)+INDUCE (non-ionic surfactant commercially available from Helena Chemical Co., reduces surface tension and allows for wetting of leaf; 0.125% V/V)
3. PYRACLOSTROBIN (109.6 G A/HA)+INDUCE (0.125% V/V)
4. PROTHIOCONAZOLE (36.5 G A/HA)+TRIFLOXYSTROBIN (109.5 G A/HA)
5. PROTHIOCONAZOLE (45.75 G A/HA)+TRIFLOXYSTROBIN (137.2 G A/HA)
6. PROTHIOCONAZOLE (36.5 G A/HA)+AZOXYSTROBIN (55 GA/HA)+TRIFLOXYSTROBIN (55 G A/HA)
7. PROTHIOCONAZOLE (45.8 G A/HA)+AZOXYSTROBIN (68.6 GA/HA)+TRIFLOXYSTROBIN (68.6 G A/HA)
8. TRIFLOXYSTROBIN (127.9 G A/HA)+INDUCE (0.125% V/V)

The trial was evaluated for fungicidal treatment effect on plant growth with respect to disease control. Ratings obtained over a four week period beginning on Sep. 4, 2009, following a single application showed all treatment processes (treatment samples 2 through 8) to be effective in controlling late season leaf spot diseases. Both frogeye and brown spot were reduced to commercially acceptable levels with each of the treatments. Treatment samples 6 and 7 of the present invention had absolute control of brown spot and the lowest level of frogeye in the trial. Defoliation was comparable among all of the treatments, with no visual difference based on greening. Greatest yield results were obtained from plots treated with treatment sample 7.

### Example 2

### Rice

Common rice (Oryza Sativa L.) was secured for an in-field research trial. The rice was conventionally seed treated prior to planting with APRON XL (commercially available from Syngenta), MAXIM (commercially available from Syngenta), and RELEASE (commercially available from Valent USA Corporation).

The site, located in Leland, Miss., was conventionally tilled and free of weeds at the time of planting. For each treatment, the rice was planted in 10 meter long rows on May 7, 2008. Each treatment sample was planted in four replicates. Broadcast spray treatments were applied on Jul. 21, 2008, to established plants.

Twelve treatment samples were prepared for comparison (treatment samples 7 and 8 are representative of the present invention):
1. The check (control) in the field trial received no application of any fungicides that may have an impact on rice growth.
2. PROTHIOCONAZOLE (153.5 G A/HA)+TRIFLOXYSTROBIN (131.5 G A/HA)
3. PROPICONAZOLE (173.5 G A/HA)+TRIFLOXYSTROBIN (173.5 G A/HA)
4. AZOXYSTROBIN (115.1 G A/HA)+PROPICONAZOLE (191.9 G A/HA) +AZOXYSTROBIN (100 G A/HA)
5. PROTHIOCONAZOLE (116.8 G A/HA)+TRIFLOXYSTROBIN (175.2 G A/HA)
6. PROTHIOCONAZOLE (146 G A/HA)+TRIFLOXYSTROBIN (219 G A/HA)
7. PROTHIOCONAZOLE (117 G A/HA)+AZOXYSTROBIN (88 GA/HA)+TRIFLOXYSTROBIN (88 G A/HA)
8. PROTHIOCONAZOLE (146 G A/HA)+AZOXYSTROBIN (109 GA/HA)+TRIFLOXYSTROBIN (109 G A/HA)
9. PROPICONAZOLE (173.5 G A/HA)+TRIFLOXYSTROBIN (173.5 G A/HA)+TRIFLOXYSTROBIN (55 G A/HA)
10. PROPICONAZOLE (173.5 G A/HA)+TRIFLOXYSTROBIN (173.5 G A/HA)+AZOXYSTROBIN (52.6 G A/HA)
11. TRIFLOXYSTROBIN (172 G A/HA)
12. PROPICONAZOLE (187.76 G A/HA)+AZOXYSTROBIN (216.89 G A/HA)

The trial was evaluated for fungicidal treatment effect on plant growth with respect to disease control. Ratings obtained over a four week period beginning on Jul. 21, 2008, following a single application showed treatment samples 3 through 12 to be more effective in controlling sheath blight than treatment sample 2. The best treatment was sample 8 of the present invention. Treatment sample 2 demonstrated good sheath blight control early, but lost effectiveness as time progressed. Treatment samples 7, 8, and 10 demonstrated the longest residual control. Treatment samples 5 and 6 did not have favorable early season control, but gained in effectiveness ad the season progressed.

Treatment sample 8 demonstrated the best yield, at 182% of the Control sample 1. Treatment samples 7 and 8 also had yielded the greatest whole and total milling quality.

### Example 3

### Corn

Sweet corn (Zea mays L. convar. saccharata) was secured for an in-field research trial.

The site, located in Sabin, Minn., was conventionally tilled and free of weeds at the time of planting. For each treatment, the corn was planted in 7.62 meter long double rows on Jun. 1, 2009. Emergence was observed on Jun. 12, 2009. Each treatment sample was planted in three replicates. Broadcast spray treatments were applied on August 10, August 19, and Aug. 31, 2009, to established plants.

Ten treatment samples were prepared for comparison (treatment samples 7 through 9 are representative of the present invention):
1. The check (control) in the field trial received no application of any fungicides that may have an impact on rice growth.
2. PROPICONAZOLE (91.5 G A/HA)+TRIFLOXYSTROBIN (91.5 G A/HA)+INDUCE (0.125% V/V)
3. PYRACLOSTROBIN (110 G A/HA)+INDUCE (0.125% V/V)
4. PROTHIOCONAZOLE (36.5 G A/HA)+TRIFLOXYSTROBIN (109.5 G A/HA)
5. PROTHIOCONAZOLE (36.5 G A/HA)+TRIFLOXYSTROBIN (109.5 G A/HA)+INDUCE (0.125% V/V)
6. PROTHIOCONAZOLE (45.75 G A/HA)+TRIFLOXYSTROBIN (137.2 G A/HA)+INDUCE (0.125% V/V)
7. PROTHIOCONAZOLE (36.5 G A/HA)+AZOXYSTROBIN (55 G A/HA)+TRIFLOXYSTROBIN (55 G A/HA)
8. PROTHIOCONAZOLE (36.5 G A/HA)+AZOXYSTROBIN (55 G A/HA)+TRIFLOXYSTROBIN (55 G A/HA)+INDUCE (0.125% V/V)
9. PROTHIOCONAZOLE (45.8 G A/HA)+AZOXYSTROBIN (68.6 G A/HA)+TRIFLOXYSTROBIN (68.6 G A/HA)+INDUCE (0.125% V/V)
10. PROTHIOCONAZOLE (36.5 G A/HA)+TRIFLOXYSTROBIN (109.5 G A/HA)+DIFORMYLUREA (65.46 G A/HA)

The trial was evaluated for fungicidal treatment effect on plant growth with respect to disease control. At the first application on August 10, tassels were fully emerged, silking in progress. A light infestation of rust pustules were present. At the second application on August 19, applied early due to impending rain, rust was observed to be developing quickly on the control. At the third application on August 31, rust on the control was much more severe, but most treatment samples looked very good. On September 14, rust on the control was severe, but most treatment samples looked very good to excellent. Treatment samples 7-9 were providing almost perfect control. On September 28, rust on the control was very severe with top leaves on control plants almost dead and drying. Most treatment samples still looked very good.

Overall, treatment samples 7-9 demonstrated superior treatments, providing near perfect rust control. These treatments not only protected the top three leaves, but provided very good control the entire length of the corn plant, which most other treatments failed to do.

Whereas particular embodiments of this invention have been described above for purposes of illustration, it will be evident to those skilled in the art that numerous variations of the details of the present invention may be made without departing from the invention as defined in the appended claims.

What is claimed is:

1. A method of improving the growth of a plant by reducing the incidence of one or more fungal infections, comprising the step of applying a foliar treatment composition at least once to established plants, wherein the treatment composition comprises effective amounts of active ingredients prothioconazole, trifloxystrobin, and azoxystrobin.

2. The method of claim 1, wherein the plant comprises corn, soybean, wheat, or rice.

3. The method of claim 1, wherein the fungal infection comprises gray leaf spot, common rust, southern rust, wheat leaf rust, Septoria, Pyricularia, and/or anthracnose.

4. The method of claim 1, wherein the effective amounts of each active ingredient are less than the amounts of each active ingredient required to obtain similar growth improvements in a similar method using only one or two of the same active ingredients.

5. The method of claim 1, wherein the prothioconazole is applied in an amount of 35 to 40 g/hectare.

6. The method of claim 5, wherein the prothioconazole is applied in an amount of 37 g/hectare.

7. The method of claim 1, wherein the trifloxystrobin is applied in an amount of 50 to 60 g/hectare.

8. The method of claim 7, wherein the trifloxystrobin is applied in an amount of 55 g/hectare.

9. The method of claim 1, wherein the azoxystrobin is applied in an amount of 50 to 60 g/hectare.

10. The method of claim 9, wherein the azoxystrobin is applied in an amount of 55 g/hectare.
